(19) United States
(12) Patent Application Publication
(10) Pub. No.: US 2025/0129448 A1
(43) Pub. Date: Apr. 24, 2025

(54) Method for the treatment of ferrous scrap comprising magnetic and non-magnetic materials and associated plant

(71) Applicant: ArcelorMittal, Luxembourg (LU)

(72) Inventors: Asier VICENTE ROJO, Castro Urdiales Cantabria (ES); Philippe Marcel RUSSO, St Julien-lès-Metz (FR)

(21) Appl. No.: 18/833,024

(22) PCT Filed: Feb. 10, 2022
(86) PCT No.: PCT/IB2022/051191

§ 371 Date: Jul. 25, 2024

(51) Int. Cl. C22B 1/00; C22B 1/24

(52) U.S. Cl. CPC C22B 1/005; C22B 1/24

(57) ABSTRACT

A method for the treatment of ferrous scrap 1 including magnetic and non-magnetic materials, the method including at least a friction step 110 wherein the ferrous scrap is subjected to a mechanical friction to obtain cleaned scrap 11 and a magnetic sorting step 120 wherein the cleaned scrap 11 is separated into a non-magnetic coarse fraction 12A and a magnetic coarse fraction 12B. An associated steelmaking method and plant is also provided.

The invention is related to a method for the treatment of ferrous scrap comprising magnetic and non-magnetic materials and to an apparatus allowing performance of the method.

### BACKGROUND

Nowadays steel scrap is commonly used in steelmaking process for the production of liquid steel. Said scrap may be used at different stages along the steelmaking process and in different steelmaking tools. Converter, Basic Oxygen Furnace (BOF), Electric Arc Furnace (EAF) are some of the tools which may notably be used for steelmaking production.

In order to reduce CO2 global footprint of the steelmaking process, there is a global trend to use more and more scrap in steel production. However, said scrap may be of different kinds, depending notably on their origin, and thus have different qualities in terms notably of shape, density, chemistry and presence of impurities. This quality has an impact on the subsequent steel production steps. Steel scrap is classified in three main categories namely home scrap, new scrap, and old scrap depending on when it becomes scrap in its life cycle.

Home scrap is the internally generated scrap during the manufacturing of the new steel products in the steel plants. This form of scrap rarely leaves the steel plant production area. Instead, it is returned to the steelmaking furnace on site and melted again. This scrap has known physical properties and chemical composition.

New scrap (also called prime or industrial scrap) is generated from manufacturing units which are involved in the fabricating and making of steel products. Scrap accumulates when steel is cut, drawn, extruded, or machined. The supply of new scrap is a function of industrial activity. When activity is high, more quantity of new scrap is generated. The chemical composition and physical characteristics of new scrap is well known. This scrap is typically clean, meaning that it is not mixed with other materials. In principle new scrap does not need any major pre-treatment process before it is melted, although cutting to size may be necessary.

Old scrap is also known as post-consumer scrap or obsolete scrap. It is steel that has been discarded when industrial and consumer steel products (such as automobiles, appliances, machinery, buildings, bridges, ships, cans, and railway coaches and wagons etc.) have served their useful life. Old scrap is collected after a consumer cycle, either separately or mixed, and it is often contaminated to a certain degree, depending highly on its origin and the collection systems. Since the lifetime of many products can be more than ten years and sometimes even more than fifty years (for example products of building and construction), there is an accumulation of iron and steel products in use since the production of steel started on a large scale. Since the old scrap is often material that has been in use for years or decades, the chemical composition and physical characteristics are not usually well known. It is also often mixed with other trash.

### SUMMARY OF THE INVENTION

In order to reduce the global footprint of produced steel, those old or obsolete scrap must be recycled and thus to be used into the steelmaking process. As mentioned above, those scrap have various qualities in terms of chemical composition or physical properties, and may they have detrimental impact on the steel to be produced.

It is an object of the present invention to provide a method and a device allowing to use more and more obsolete scrap without impairing the quality of the steel to be produced.

The present invention provides a method comprising at least a friction step wherein the ferrous scrap is subjected to a mechanical friction to obtain cleaned scrap and a magnetic sorting step wherein the cleaned scrap is separated into a non-magnetic coarse fraction and a magnetic coarse fraction.

The method of the invention may also comprise the following optional characteristics considered separately or according to all possible technical combinations:
before the friction step, a first size screening step is performed, wherein scrap is separated by vibration into at least a first fine fraction with particles size inferior to at most 30 mm and a coarse fraction and the coarse fraction is subjected to the friction step,
after the magnetic sorting step, the magnetic coarse fraction is subjected to a densiometric screening step wherein it is separated into at least a second fine fraction with particles size inferior to at most 40 mm and a high-quality scrap fraction,
after the first size screening step, the first fine fraction is further subjected to a magnetic sorting step to separate it into a non-magnetic fine fraction and a magnetic fine fraction,
the magnetic fine fraction is subjected to a briquetting step to form briquettes,
the non-magnetic fine fraction is subjected to an extraction step wherein metals, plastics and rubbers and sterile materials contained in the non-magnetic fine fraction are respectively separated from each other.
the non-magnetic coarse fraction is subjected to an extraction step wherein metals, plastics and rubbers and sterile materials contained in the non-magnetic coarse fraction are respectively separated from each other,
the extraction step is performed using Eddy current,
the densiometric screening step comprises the separation of the magnetic coarse fraction into high quality scrap, scrap having a particle size comprised between 4 and 40 mm and iron fines,
the iron fines are subjected to a briquetting step,
the rubber and plastics obtained in the extraction step are charged into a steel or iron-making furnace.

The invention is also related to a steelmaking method using high quality scrap obtained by a method according to anyone of the previous claims.

The invention is also related to a plant for the treatment of ferrous scrap comprising magnetic and non-magnetic materials, said plant comprising a friction device able to subject the ferrous scrap to a mechanical friction to obtain a cleaned scrap and a magnetic sorting device able to separate the cleaned scrap into a non-magnetic coarse fraction and a magnetic coarse fraction.

The plant of the invention may also comprise the following optional characteristics considered separately or according to all possible technical combinations:
the plant further comprises a first vibratory screening device allowing to separate ferrous scrap by vibration into at least a first fine fraction with particles size inferior to at most 30 mm and a coarse fraction,
the plant further comprises a densiometric screening device able to separate the magnetic coarse fraction into at least a second fine fraction with particles size inferior to at most 40 mm and a high-quality scrap fraction,
the first vibratory screening device is a sieve,
the densiometric screening device is a vibratory table,
the plant further comprises a briquetting device.
the plant further comprises an extraction device able to extract metals, plastics and rubbers and sterile materials,
the extraction device uses Eddy current.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates a method according to a first embodiment of the invention

FIG. 2 illustrates a method according to a second embodiment of the invention Elements in the figures are for illustration purposes and may not have been drawn to scale.

### DETAILED DESCRIPTION

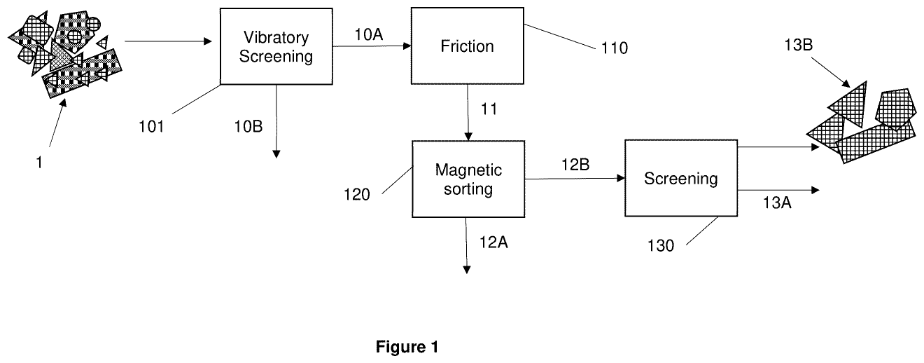

FIG. 1 illustrates a method according to a first embodiment of the invention. In this method, scrap 1 comprising both magnetic and non-magnetic fractions is subjected to several treatment steps to obtain high-quality scrap 13B for further use in the steelmaking process. Scrap 1 is for example old scrap, shredded scrap, steel turnings, fragmentized scrap from incineration. It may be E1, E40, E5H, E5M, E46, EHRM specification scrap according to EU-27 steel scrap specification, last update of May 2007.

Scrap 1 is first preferentially subjected to a first size screening step 101 wherein scrap 1 is separated by vibration between at least a first fine fraction 10B with particles size inferior to at most 30 mm and a coarse fraction 10A. By at most 30 mm it is meant that the invention encompasses any separation performed at a level below 30 mm, for example 20 mm.

This first size screening step 101 is performed by a screener and/or a sieve. In screens and sieves, thanks to their screening grids with variable filtering dimensions, scrap material is guided through the inlet distributor to the screening grid that vibrates horizontally. The grids are integrated into the screening box and can be removed both from above and from the front of the machine, which greatly facilitates cleaning and maintenance. The configuration of the screening box is horizontal, and its operation depends on the input material, the inclination of the screening screen, the number of collisions between particles and their speed. All these variables can be controlled and modified looking for the most optimal classification for each input material. Also, the output material will be classified into different outputs, depending on its size.

The coarse fraction 10A, or scrap 1 when step 101 is not performed, is then subjected to a friction step 110. This friction step 110 allows mechanical removal of the superficial oxide layers and dirt present on scrap. A chemical addition may be performed during the friction step 110 to further improve the removal of the oxides. This may be performed in a rotating drum; the friction being done by the contact between the scrap pieces. This rotating drum may be preferentially perforated as a sieve so that the removed oxide layers in form of dust can directly be extracted. The friction step 110 allows destroying of joints and welding, as well as of separating the iron-containing elements from the other elements contained in the scrap. Moreover, by removing the oxides which are not conductive, it ensures that the following process step of magnetic sorting will be efficient.

The cleaned scrap 11 obtained after friction step 110 is then subjected to a magnetic sorting step 120 where it is separated between a non-magnetic coarse fraction 12A and a magnetic coarse fraction 12B. This sorting step 120 allows removal of notably non-magnetic metals such as lead, copper, tin, zinc, aluminium which may be detrimental for steel quality but also organic materials such as glass, plastics or cardboards from scrap. This sorting step 120 is more efficient as the size of the scrap parts is uniform which is the purpose of the first screening step 101.

This sorting 120 may be performed according to different techniques. High gradient magnetic separators maybe used to extract weakly magnetic material that can be found in dry material with fine granulometry as impurities. This separator creates a high intensity magnetic field of high gradient capable of attracting very weak magnetic materials such as iron oxides and paramagnetic materials. This separator consists of a vibrating feeder that receives the product and distributes it evenly in a thin layer, over a special antistatic band. The drive roller is provided by permanent magnets of very high magnetic power (rare earths) and steel magnetic poles of high permeability. The material transported by the conveyor reaches the magnetic roller and is exposed to its magnetic field. The attracted magnetic particles accompany the roller in its rotation movement and detach behind the roller, in a different falling trajectory than the nonmagnetic material which falls freely without being influenced by the magnetic field. Two small hoppers collect and evacuate the magnetic material and the clean product. Dry magnetic separators may be used to extract and retain ferromagnetic parts that occasionally are among the material that circulates on the conveyor belt.

The coarse magnetic fraction 12B is then optionally subjected to a densiometric screening step 130 where it is separated between at least a second fine fraction 13A with particles size inferior to at most 40 mm and a high-quality scrap fraction 13B. In a preferred embodiment, this densiometric screening step 130 allows to separate between at least a second fine fraction 13A with particles size inferior to at most 40 mm, a high-quality scrap fraction 13B and iron fines 13C. Iron fines 13C usually have a size inferior to 4 mm.

This densiometric screening step is needed as smaller scrap particles 13A are difficult to handle with conventional scrap handling tools and to charge into buckets for loading into the steelmaking furnaces. Those small pieces are moreover more prone to collect moisture from rain and are easily oxidable compared to the high-quality scrap fraction 13B, they must thus be quickly consumed while the high-quality scrap fraction 13B may be stored in stockyards.

As suggested by its name, this densiometric screening step 130 allows separation of the particles of different sizes using their density differences. It may be performed using a vibrational table. The material is dosed on a vibrating porous surface through which air is blown. Denser materials remain longer in contact with the surface and are pushed forward, while less dense materials remain less in contact with the vibrating surface and tend to move back or remain static. The threshold density can be selected by adjusting the operational parameters of the table (vibration speed, air flow rate and table inclination).

This densiometric screening step 130 may also be performed using a cyclone separator, a drum separator or a flotation separator.

The high-quality scrap fraction 13B has preferentially same properties as E2, E6, E8 scrap according to EU-27 steel scrap specification, last update of May 2007. It may then be used in steel production, as load for an electric furnace or a converter.

In the case that densiometric screening step 130 is not performed, the coarse magnetic fraction 12B may be directly used in steel production as the high-quality scrap fraction 13B.

The first screening step 101 is performed at a higher size level of separation than the densiometric screening step 130 so that a bigger quantity of scrap is subjected to the subsequent steps of friction and sorting and both the second fine fraction 13A and high-quality scrap fraction 13B may then be used in the steelmaking production without impairing produced steel quality.

The method according to the invention allows use of what is considered as obsolete, or low-quality scrap, in steel production with a limited or no impact on the process conditions and/or on the quality of the produced steel.

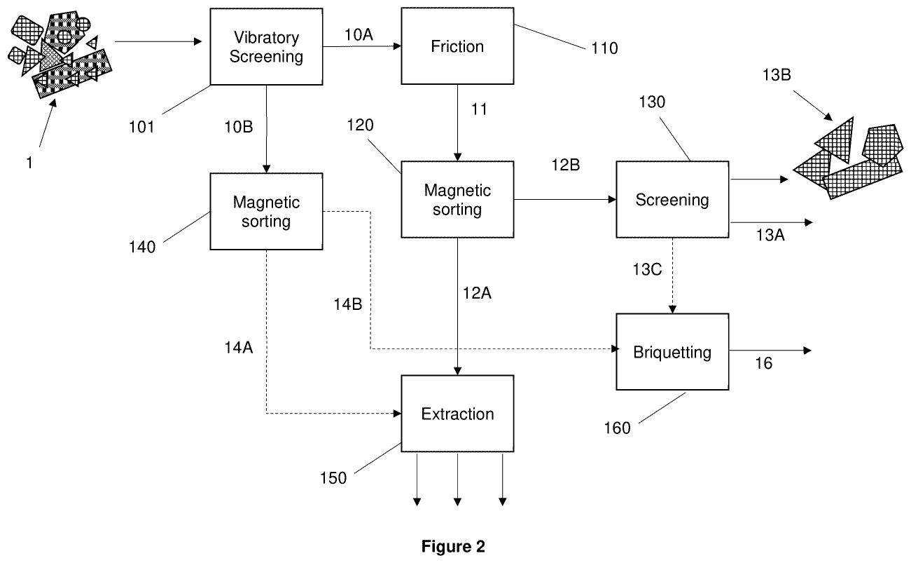

FIG. 2 illustrates a method according to a second embodiment of the invention. In this embodiment all the steps of the first embodiment are reproduced but with additional steps in order to manage the different by-products generated by the first embodiment. All the different equipment and/or methods describe to perform the steps of the first embodiment may thus be applied to the same steps of this second embodiments and will not be repeated.

Scrap 1 is first subjected to a first size screening step 101 wherein scrap 1 is separated by vibration between at least a first fine fraction 10B with particles size inferior to at most 40 mm and a coarse fraction 10A. While the coarse fraction 10A is subjected to a friction step 110, the first fine fraction 10B is subjected to a magnetic sorting step 140. This magnetic sorting step 140 may use same equipment and/or method as described for the magnetic sorting step 120. This magnetic sorting step 140 allows to split the first fine fraction 10B between a non-magnetic fine fraction 14A and a magnetic fine fraction 14B.

The non-magnetic fine fraction 14A may be then subjected to an extraction step 150. This extraction step 150 allows separation of, from the non-magnetic fine fraction 14A, the metallic components, such as copper, aluminium or chromium which may then be sold, rubber and plastics which may then be re-used as carbon-source into the steel production and the sterile materials which are generally disposed of.

This extraction step 150 may be a separation by electrical conductivity. Those separation technologies are mainly based on electric currents, preferably Eddy currents, electromagnetic induced in a conductive material when it moves in a spatial region in which there is a variable magnetic field. These induced currents generate a magnetic field opposite to the external magnetic field. Non-conductive materials do not develop Foucault currents and, therefore, the opposite magnetic field is not generated. In the case of Eddy current separators, the opposite magnetic field produces Lorentz force which allows separation. Since non-conductive materials do not undergo changes in their trajectory (as the magnetic field is not induced), it is possible to separate conductive particles from non-conductive particles.

This Eddy current separation 150 may be performed using an equipment composed of a long ramp consisting of permanent magnet bands of alternating polarity mounted on a steel plate. When dropping the stream of non-magnetic fine fraction 14A down the ramp, non-conductor materials descend through the branch without movement diversion, while the displacement of the conductive materials, under the influence of Lorentz's repulsive force (perpendicular to the magnetic bands) induced by Eddy currents is altered and the conductive particles are thus separated from the non-conductive particles.

The magnetic fine fraction 14B may be subjected to a briquetting step 160.

With the magnetic sorting step 140 and the extraction step 150, the first fine fraction 10B is then almost fully valorised.

According to the invention, the coarse fraction 10A is subjected to a friction step and the cleaned scrap 11 is then subjecting to the magnetic sorting step 120 where it is split between a non-magnetic coarse fraction 12A and a magnetic coarse fraction 12B.

According to an embodiment of the invention, the non-magnetic coarse fraction 12A is also subjected to the extraction step 150. This step is preferentially performed with the same equipment as the extraction step of the non-magnetic fine fraction. The aim is the same, to separate from the non-magnetic fine fraction 14A, the metallic components, such as copper, aluminium or chromium which may then be sold, rubber and plastics which may then be re-used as carbon-source into the steel production and the sterile materials which are generally disposed of.

According to a preferred embodiment of the invention, the magnetic-coarse fraction 12B is subjected to the densiometric screening step 130 where it is separated between at least a second fine fraction 13A with particles size inferior to 40 mm, a high-quality scrap fraction 13B and iron fines 13C. While the second fine fraction 13A and the high-quality scrap fraction 13B may be used into the steel production process, the iron fines 13C may be subjected to a briquetting step 160 as the magnetic fine fraction 14B to form briquettes 16. In a preferred embodiment, both iron fines 13C and magnetic fine fraction 14B are briquetted into the same briquetting equipment. Briquettes 16 thus formed may then be used into the steelmaking production process.

Combination of those different embodiments allows to valorise most of the content of the initial scrap 1 and thus to limit the overall environmental footprint.

1-20. (canceled)

21. A method for the treatment of ferrous scrap comprising magnetic and non-magnetic materials, the method comprising at least the following steps:
A. a friction step wherein the ferrous scrap is subjected to a mechanical friction to obtain cleaned scrap; and
B. a magnetic sorting step wherein the cleaned scrap is separated into a non-magnetic coarse fraction and a magnetic coarse fraction.

22. The method as recited in claim 21 wherein before the friction step, a first size screening step is performed, wherein the ferrous scrap is separated by vibration into at least a first fine fraction with particle size inferior to at most 30 mm and a coarse fraction and the coarse fraction is subjected to the friction step.

23. The method as recited in claim 21 wherein, after the magnetic sorting step, the magnetic coarse fraction is subjected to a densiometric screening step wherein the magnetic coarse fraction is separated into at least a second fine fraction with particles size inferior to at most 40 mm and a high-quality scrap fraction.

24. The method as recited in claim 22 wherein after the first size screening step, the first fine fraction is further subjected to a magnetic sorting step to separate the first fine fraction into a non-magnetic fine fraction and a magnetic fine fraction.

25. The method as recited in claim 24 wherein the magnetic fine fraction is subjected to a briquetting step to form briquettes.

26. The method as recited in claim 24 wherein the non-magnetic fine fraction is subjected to an extraction step wherein metals, plastics and rubbers and sterile materials contained in the non-magnetic fine fraction are respectively separated from each other.

27. The method as recited in claim 21 wherein the non-magnetic coarse fraction is subjected to an extraction step wherein metals, plastics and rubbers and sterile materials contained in the non-magnetic coarse fraction are respectively separated from each other.

28. The method as recited in claim 26 wherein the extraction step is performed using Eddy current or wherein the non-magnetic coarse fraction is subjected to a further extraction step wherein metals, plastics and rubbers and sterile materials contained in the non-magnetic coarse fraction are respectively separated from each other using Eddy current.

29. The method as recited in claim 23 wherein the densiometric screening step comprises the separation of the magnetic coarse fraction into scrap having a particle size comprised between 4 and 40 mm and iron fines and high quality scrap.

30. The method as recited in claim 29 wherein the iron fines are subjected to a briquetting step.

31. The method as recited in claim 27 wherein the rubber and plastics obtained in the extraction step are charged into a steel or iron-making furnace.

32. A steelmaking method employing high quality scrap fraction obtained by the method as recited in claim 23.

33. A plant for the treatment of ferrous scrap comprising magnetic and non-magnetic materials, said plant comprising the following:
a friction device able to subject the ferrous scrap to a mechanical friction to obtain a cleaned scrap; and
a magnetic sorting device able to separate the cleaned scrap into a non-magnetic coarse fraction and a magnetic coarse fraction.

34. The plant as recited in claim 33 further comprising a first vibratory screening device allowing to separate ferrous scrap by vibration into at least a first fine fraction with particles size inferior to at most 30 mm and a coarse fraction.

35. The plant as recited in claim 33 further comprising a densiometric screening device able to separate the magnetic coarse fraction into at least a second fine fraction with particles size inferior to at most 40 mm and a high-quality scrap fraction.

36. The plant as recited in claim 34 wherein the first vibratory screening device is a sieve.

37. The plant as recited in claim 35 wherein the densiometric screening device is a vibratory table.

38. The plant as recited in claim 33 further comprising a briquetting device.

39. The plant as recited in claim 33 further comprising an extraction device able to extract metals, plastics and rubbers and sterile materials.

40. The plant as recited in claim 39 wherein the extraction device uses Eddy current.
